(19) United States
(12) Patent Application Publication
(10) Pub. No.: US 2019/0318315 A1
(43) Pub. Date: Oct. 17, 2019

(54) METHOD FOR JOB MATCHING AND A SYSTEM THEREFOR

(71) Applicant: CXS Analytics Sdn Bhd, Cyberjaya (MY)

(72) Inventors: Connor CLARK-LINDH, Singapore (SG); Jan Ernst F. LAMBRECHTS, Cyberjaya (MY); Yee Chee KEAN, Cyberjaya (MY)

(73) Assignee: CXS Analytics Sdn Bhd, Cyberjaya (MY)

(21) Appl. No.: 15/952,852

(22) Filed: Apr. 13, 2018

(30) Foreign Application Priority Data
Apr. 13, 2018 (MY) PI 2018701469

(51) Int. Cl. G06Q 10/10; G06Q 10/06; G06N 99/00

(52) U.S. Cl. CPC G06Q 10/1053; G06N 99/005; G06Q 10/063112

(57) ABSTRACT

A method for matching jobs includes providing a master skill ledger module for identifying skills, wherein the skills are grouped into clusters and categories, providing a platform for receiving hiring requirements from employers and applications from applicants, analyzing the hiring requirements and producing job profiles which are associated with the master skill ledger module, analyzing the applications from the applicants and producing applicant profiles which are associated with the master skill ledger module, matching the applicant profiles with the job profiles and generating a matching score thereof, providing recommendations to the employer based on the matching score, receiving and processing rating from the employers on the recommendations, if any. The rating received from the employer is directed as input for training of the artificial intelligence processing.

### FILED OF THE INVENTION

The present invention relates to a method for matching job and more particularly the present invention relates to a job matching method based on artificial intelligence.

### BACKGROUND OF THE INVENTION

United States patent application publication no 20120330708 A1 disclosed a method which permits hiring managers and jobseekers to receive a ranked list of matching resumes for their posted jobs and resumes respectively. The system administrators and the engine validates the jobs and resumes prior to executing the matching process. The validated jobs and resumes are automatically matched by the matching engine creating a ranked list of resumes for each job and jobs for each resume. The job and resume owners are notified of the matches for further action.

United States patent application publication no. 20010042000 A1 disclosed a method of matching job candidates with jobs in a specific city or region. The method includes creating an accessible database, such as an Internet web site, which is representative of a city or region, and a particular career field. Job candidates with skills or training in that career field who are interested in the specified city or region will come to the web site and post their qualifications in a specific skills matrix which incorporates very specific skill, competency and experience components.

U.S. Pat. No. 7,720,791 B2 disclosed a job searching and matching system and method that gathers job seeker information in the form of job seeker parameters from one or more job seekers, gathers job information in the form of job parameters from prospective employers and/or recruiters, correlates the information with past job seeker behavior, parameters and behavior from other job seekers, and job parameters and, in response to a job seeker's query, provides matching job results based on common parameters between the jobseeker and jobs along with suggested alternative jobs based on the co-relationships and based on ratings and preferences provided by the job seeker and provides negative filtration of undesirable jobs based on job seeker input and in response to queries from the system in order to efficiently and accurately accommodate job seeker perception.

In general, the current approach in the market is fragmented screening, matching and profiling solutions. Recruiting firms address hiring issues in isolation to the overall dynamics in the company and are not able to recommend hires who are the best fit to the environment and organization. Instead, those who fit a job specification are recommended.

Profiling firms create individual, team and organizational profiles which are used in isolation to support internal communication, review and selection of people. Profiling tool providers do not validate the recommendations of the tools and results vary based on how well the tools are implemented, maintained and utilized within the company.

Consulting firms focus on organizational improvement through targeted strategies and initiatives which do not allow for rapid experimentation, simulation of work environments or incremental improvement. Consulting is an all-or-nothing initiative. Failures are blamed on the organization incorrectly implementing recommendations.

There is abundance of personality profiling tools which are used in isolation. Skill tests and automated recruited solutions are likewise isolated. Consulting recommendations are made and implemented without validation.

These systems rely on the employer to tie together the various recommendations and data points into a common system, profile and judgement manually. More commonly, each result is reviewed in isolation as a pass-or-fail rating of the job seeker. These tools become a a way for employers to validate assumptions rather than supporting the hiring process.

The present invention provides an automated, self-improving job matching method and system for use by both the jobs seeker and the employer. The present invention provides integrated system from pre-hire, screening/selection, onboarding, performance management and offboarding with profiling, testing and automated screening.

### SUMMARY OF THE INVENTION

It is an objective of the present invention to provide method for jobs matching in which the matching is automated and adjustable manually and through feedback from the results of the matching.

It is also an objective of the present invention to provide a jobs matching method which is executed using artificial intelligence with self-improving capabilities.

It is also an objective of the present invention to provide a jobs matching method with a stored master list of skills for selection by the employer and the applicant, and for the matching of the skills.

The present invention relates to a method for matching jobs comprising providing a master skill ledger module for identifying skills, wherein the skills are grouped into clusters and categories, providing a platform for receiving hiring requirements from employers and applications from applicants, analyzing the hiring requirements and producing job profiles which are associated with the master skill ledger module, analyzing the applications from the applicants and producing applicant profiles which are associated with the master skill ledger module, matching the applicant profiles with the job profiles and generating a matching score thereof, providing recommendations to the employer based on the matching score, receiving rating from the employers on the recommendations, wherein the grouping of skills into clusters and categories, producing of job profile, producing of applicant profile, and generating of matching score, or any one or any combination thereof are performed using artificial intelligence processing, wherein the rating received from the employer is directed as input for training the artificial intelligence processing.

In a preferred embodiment, the method further comprises, after receiving the applications, providing recommendations on the skills, skill cluster, skill categories to the applicants for the applicants to include into the applicant profile.

In a preferred embodiment, the hiring requirements comprises selectable skills, skill clusters or categories, profile attribute, a job description, an applicant profile of another applicant, or any combination thereof.

In a preferred embodiment, the matching of the applicant profiles with the job profiles is performed by ranking and comparing the applicant profiles with the job profiles.

In a preferred embodiment of the present invention, the artificial intelligence processing used includes any one or combination of machine learning, deep learning, and natural language processing.

In a preferred embodiment, the rating on the recommendations is received after recommendations is provided, after an interview with the applicant by the employer, or after the applicant has been recruited.

The present invention further relates to a system for matching jobs comprising a master skill ledger module for identifying skills, wherein the skills are grouped into clusters and categories, a platform provided over a network for receiving hiring requirements from employers and applications from applicants and receiving rating from the employers on recommendations. A matching module is configured for analyzing the hiring requirements and producing job profiles which are associated with the master skill ledger module, analyzing the applications from the applicants and producing applicant profiles which are associated with the master skill ledger module, and matching the applicant profiles with the job profiles and generating a matching score thereof, providing recommendations to the employer based on the matching score, wherein the grouping of skills into clusters and categories, producing of job profile, producing of applicant profile, and generating of matching score, or any one or any combination thereof are performed using artificial intelligence processing, wherein the rating received from the employer is directed as input for training the artificial intelligence processing.

### BRIEF DESCRIPTION OF THE DRAWING

FIG. 1 is flow chart showing a method for matching hiring requirements with applications from applicants according to an embodiment of the present invention.

### DETAILED DESCRIPTION OF THE PREFERRED EMBODIMENT

The present invention will now be described in more detail with reference to the accompanying drawing, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art.

The term applicant (20) as used throughout the specification is understood and construed the job seeker or candidate, who is making, or has made an application to a job position as provided in the present method and system.

The term employer (10) as used throughout the specification is understood and construed as the client or the company which is seeking to recruit a new employee, or which has posted a job posting, or which has recruited a new employee via the present method and system.

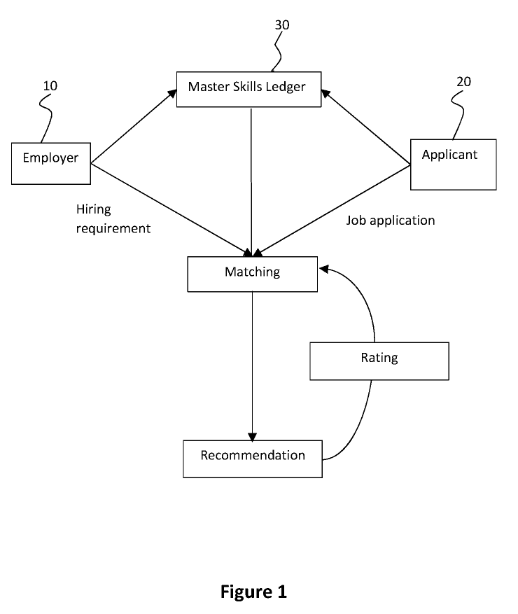

With reference to FIG. 1, the present invention relates to a method for matching jobs comprising providing a master skill ledger (30) module for identifying skills, wherein the skills are grouped into clusters and categories, providing a platform for receiving hiring requirements from employers (10) and applications from applicants (20), analyzing the hiring requirements and producing job profiles which are associated with the master skill ledger (30) module, analyzing the applications from the applicants (20) and producing applicant profiles which are associated with the master skill ledger (30) module, matching the applicant profiles with the job profiles and generating a matching score thereof, providing recommendations to the employer (10) based on the matching score, receiving and processing rating from the employers (10) on the recommendations. The rating received from the employer (10) is directed as input for training the artificial intelligence processing.

The present invention employs artificial intelligence processing in performing the job matching process. In particular, the grouping of skills into clusters and categories, producing job profile, producing applicant profile, and generating matching score, or any one or any combination thereof are performed using artificial intelligence processing.

In a preferred embodiment, the master skill ledger (30) module is stored in a database of a server. In a preferred embodiment, the master skill ledger (30) module uses natural language processing (NLP) techniques to process live job data, resumes and curriculum vitae and other data sources to identify common skills and skill clusters. Clusters are used to identify live job functions and relationships between skills. Using this process, a master list of skills is generated. Skill clusters are filtered into job categories.

In a preferred embodiment, a panel of experts review skills and skill clusters in the master skill ledger (30) module. This review process is conducted training for the NLP or Deep Learning system to improve the identification and sorting of skills. Also, a process of manually connecting synonyms, redundancy and false connections may be used for adjusting the review process. Alternatively, the review process is conducted with combination of NLP or Deep Learning together with manual adjusting.

As needed the live master skill ledger (30) may be localised (through branching of the main ledger) to the unique needs of an industry or location. For example, a sales person in retail may have a different set of skills than a sales manager in industrial chemicals.

In a preferred embodiment, when a skill is selected in an application by an applicant (20) or a hiring requirement by an employer (10), validation on the skills is conducted. For applicants (20) or job seekers this could be a third-party assessment or some other form of verification. A panel of experts reviews skills and recommends validation processes for each skill. For hiring requirements, the employer (10) can validate the skill requirement by going through a series of question regarding the nature of work which is built from the processed data.

Validation of skills allows for more accurate matching and for job seekers and employers (10) to rank based on competency level. In a preferred embodiment, the skills may be ranked with numerical values. For example, a ranking of 3 levels may be employed.

In a preferred embodiment, the present method further comprises, after receiving the applications, providing recommendations on the skills, skill cluster, skill categories to the applicants (20) for the applicants to include into the applicant profile.

When an applicant (20) applies for a role, the system analyses their documents including resume, social media profiles, etc and recommends a suitable list of matching skills and job functions or skill clusters. The applicant (20) can further enhance their profile by manually adding skills and adjusting their job functions. They can further include an “interested in” job function where they will be recommended to roles where the client or the employer (10) is open to people who are interested in that role and have similar skills.

In a preferred embodiment, the employer (10) when posing a hiring requirement, may select skills, skill clusters or skill categories, profile attribute. The employer (10) may also pose a job description, an applicant profile of another applicant (20) to the system. For example, when a company creates a hiring requirement, they can manually select suitable skills, skill clusters, and interest preferences or they can upload a job description or profile of a previous person in the role. The target profile for the job requirement can be further enhanced through Machine Learning by uploading profiles of previously successful applicant for that role. The company can also select preferred profile attributes for the role which will influence the final recommendations through weighting.

In the matching of the applicant profiles with the job profiles, the matching process is performed by ranking and comparing the applicant profiles with the job profiles. Once the job seekers and job requirements have been categorized the system uses a rank-and-compare approach to sort the list of applicants (20) against each role. This ranking can be further adjusted automatically by the system via feedback. As the hiring company or job seeker makes selections, interacts with the system, the system adjusts accordingly. The rankings can also be weighted manually to give preference to certain types of job seekers or force recommendations that fit certain criteria like gender balance and so forth.

Additionally, as the applicants (20) and the employers (10) go through the process, they are given alternative recommendations based on the similarities between their selections and the main dataset. An applicant (20) may be recommended to include additional skills or consider different roles. Alternatively, similar skills and skill clusters will be recommended to an employer (10) to improve the available talent pool for the role.

The artificial intelligence processing used in analyzing the application and hiring requirement includes any one or combination of machine learning, deep learning, and natural language processing.

As applicants (20) apply to the role, the system will automatically process each incoming profile, resume or curriculum vitae and match it against the job profile to produce a matching score. Based on that score relative to the scores of the other applicants (20), the system will recommend the top choices for interview.

In a preferred embodiment, the rating on the recommendations is received after recommendations is provided, after an interview with the applicant (20) by the employer (10), or after the applicant (20) is recruited. In this regard, the platform may prompt the employer (10) for the input of rating on the provided recommendations. Each rating provides feedback to the Machine Learning system, which improves future recommendations. After interview, post hire and during the development of that professional, the Company can rate the fit of the professional which will further train the Machine Learning system for that company and role.

The present invention further relates to a system for matching jobs comprising a master skill ledger (30) module for identifying skills, wherein the skills are grouped into clusters and categories, a platform provided over a network for receiving hiring requirements from employers (10) and applications from applicants (20), and receiving rating from the employers (10) on recommendations; a matching module configured for analyzing the hiring requirements and producing job profiles which are associated with the master skill ledger (30) module, analyzing the applications from the applicants (20) and producing applicant profiles which are associated with the master skill ledger (30) module, and matching the applicant profiles with the job profiles and generating a matching score thereof, providing recommendations to the employer (10) based on the matching score, wherein the grouping of skills into clusters and categories, analyzing the applications and the hiring requirements, and generating of matching score, or any one or any combination thereof are performed using artificial intelligence processing, wherein the rating received from the employer (10) is directed as input for training of the artificial intelligence processing.

In a preferred embodiment, the jobs matching may be further enhanced with a three-step process. Firstly, the applicants (20) and hiring requirements are matched based on their interests and preferences. Hire requirements are automatically categorised based on research-validated job-interest groups.

Secondly, the sub-set of applicants (20) that match the interests and preferences of the job are then matched based on the skill cluster of their profile and any interests that they have manually selected against the skill cluster of the job role.

Thirdly, the sub-set of further matched applicants (20) are then matched on an individual skills basis to the skills required for the job.

Although the present invention has been described in a specific embodiment as in the above description, it is understood that the above description does not limit the invention to the above given details. It will be apparent to those skilled in the art that various changes and modification may be made therein without departing from the principle of the invention or from the scope of the appended claims.

1. A method for matching jobs comprising:
providing a master skill ledger (30) module for identifying skills, wherein the skills are grouped into clusters and categories,
providing a platform for receiving hiring requirements from employers (10) and applications from applicants (20),
analyzing the hiring requirements and producing job profiles which are associated with the master skill ledger (30) module,
analyzing the applications from the applicants (20) and producing applicant profiles which are associated with the master skill ledger (30) module,
matching the applicant profiles with the job profiles and generating a matching score thereof,
providing recommendations to the employers (10) based on the matching score,
receiving and processing rating from the employers (10) on the recommendations,
wherein the grouping of skills into clusters and categories, analyzing the hiring requirements and applications from the applicants (20), generating matching score, or any one or any combination thereof are performed using artificial intelligence processing,
wherein the rating received from the employers (10) is directed as input for training of the artificial intelligence processing.

2. A method for matching jobs according to claim 1, wherein the master skill ledger (30) module processes applications from the applicants (20) to identify skills and skill clusters.

3. A method for matching jobs according to claim 1, wherein the skill clusters in the master skill ledger (30) are used to identify live job functions and relationships between skills.

4. A method for matching jobs according to claim 1, wherein the method further comprises, after receiving the applications, providing recommendations on the skills, skill clusters, skill categories to the applicants (20) for the applicants to include into the applicant profiles.

5. A method for matching jobs according to claim 1, wherein the hiring requirements comprises selectable skills, skill clusters or categories, profile attribute, a job description, an applicant profile of another applicant (20), or any combination thereof.

6. A method for matching jobs according to claim 1, wherein analyzing the hiring requirements and applications comprises categorizing the hiring requirements and applications to the skills, skill clusters or categories.

7. A method for matching jobs according to claim 1, wherein the matching of the applicant profiles with the job profiles is performed by ranking and comparing the applicant profiles with the job profiles.

8. A method for matching jobs according to claim 1, wherein the artificial intelligence used includes any one or a combination of machine learning, deep learning, and natural language processing.

9. A method for matching jobs according to claim 1, wherein the rating on the recommendations is received after recommendations is provided, after an interview with the applicant (20) by the employer (10), or after the applicant (20) is recruited.

10. A system for matching jobs comprising:
a master skill ledger (30) module for identifying skills, wherein the skills are grouped into clusters and categories,
a platform provided over a network for receiving hiring requirements from employers (10) and applications from applicants (20), and receiving rating from the employers (10) on recommendations;
a matching module configured for
analyzing the hiring requirements and producing job profiles which are associated with the master skill ledger (30) module,
analyzing the applications from the applicants (20) and producing applicant profiles which are associated with the master skill ledger (30) module, and
matching the applicant profiles with the job profiles and generating a matching score thereof,
providing recommendations to the employer (10) based on the matching score,
wherein the grouping of skills into clusters and categories, analyzing of applications from the applicants and hiring requirements from the employer, and generating of matching score, or any one or any combination thereof are performed using artificial intelligence processing,
wherein the rating received from the employer (10) is directed as input for training of the artificial intelligence processing.

11. A system for matching jobs according to claim 10, wherein the matching module is further configured for providing recommendations on the skills, skill clusters, skills categories as stored in the master skill ledger (30) module to the applicants (20) for the applicants to include into the applicant profile.

12. A system for matching jobs according to claim 10, wherein the platform is configured for receiving hiring requirements which comprise selectable skills, skill clusters or categories, profile attribute, a job description, an applicant profile of another applicant (20), or any combination thereof.

13. A system for matching jobs according to claim 10, wherein the matching of the applicant profiles with the job profiles in the matching module is performed by ranking and comparing the applicant profiles with the job profiles.

14. A system for matching jobs according to claim 10, wherein the artificial intelligence processing used includes any one or combination of machine learning, deep learning, and natural language processing.

15. A system for matching jobs according to claim 10, wherein the system is configured for receiving and processing rating on the recommendations after recommendations is provided, after an interview with the applicant (20) by the employer (10), or after the applicant (20) is recruited.
